(19) United States
(12) Patent Application Publication
(10) Pub. No.: US 2025/0094897 A1
(43) Pub. Date: Mar. 20, 2025

(54) DISPLAY CONTROL DEVICE, DISPLAY CONTROL METHOD, AND DISPLAYCONTROL PROGRAM

(71) Applicant: NIPPON TELEGRAPH AND TELEPHONE CORPORATION, Tokyo (JP)

(72) Inventors: Atsuhiko MAEDA, Tokyo (JP); Kenichi FUKUDA, Tokyo (JP); Masato KAMIYA, Tokyo (JP); Yukio KIKUYA, Tokyo (JP)

(73) Assignee: NIPPON TELEGRAPH AND TELEPHONE CORPORATION, Tokyo (JP)

(21) Appl. No.: 18/730,286

(22) PCT Filed: Jan. 27, 2022
(86) PCT No.: PCT/JP2022/003136

§ 371 Date: Jul. 18, 2024

(51) Int. Cl. G06Q 10/0631; G06Q 10/0635; G06Q 50/22

(52) U.S. Cl. CPC G06Q 10/06312; G06Q 10/0635; G06Q 50/22

(57) ABSTRACT

A display control device estimates an occurrence time at which a call occurs at an occurrence point for each of a plurality of occurrence points on the basis of a predictive distribution of an occurrence point representing a point where a call for an emergency vehicle occurs. The display control device executes a simulation of an emergency activity in which any one of a plurality of emergency vehicles available for dispatch is dispatched to the occurrence point at the occurrence time for each of the plurality of occurrence points on the basis of the occurrence time of each of the plurality of occurrence points and an operational status of each of the plurality of emergency vehicles. On the basis of a simulation result, the display control device extracts, from the plurality of occurrence points, an occurrence point at which the distance between an emergency vehicle available for dispatch and the occurrence point is equal to or greater than a threshold, and calculates a risk level such that the risk level of an area to which the extracted occurrence point belongs becomes high. The display control device controls a display unit to display the risk level.

### TECHNICAL FIELD

The disclosed technology relates to a display control device, a display control method, and a display control program.

### BACKGROUND ART

A technology related to a system for optimal operation of ambulance vehicles using emergency big data has conventionally been known (see, for example, Non Patent Literature 1). Non Patent Literature 1 discloses a technology aimed at shortening the time required for arrival at a scene and the time required for transport to a hospital when an ambulance takes a sick or injured person to the hospital.

### CITATION LIST

### Non Patent Literature

Non Patent Literature 1: National Research Institute of Fire and Disaster, Nippon Telegraph and Telephone Corporation, and NTT DATA Corporation, “Kyukyubiggudetawo mochiita kyukyujidoushasaitekiunyou sisutemuno yukouseiwokakunin-riarutaimunakyukyujyuyouyosokunadoniyoru kyukyushano hansoujikantanshukuwo mezasu (Japanese) (System for optimal operation of ambulance vehicles using emergency big data has been confirmed to be effective—for reduction of ambulance transport time by real-time emergency demand prediction and the like)”, [online], Nov. 26, 2018, [Searched on Oct. 16, 2020], Internet <URL:https://www.ntt.co.jp/news2018/1811/181126a.html>

### SUMMARY OF INVENTION

### Technical Problem

By the way, in some cases, an ambulance, which is an example of an emergency vehicle, when called for, takes a longer time than expected to arrive at the point where the ambulance call has been made depending on the dispatch status of the ambulance. In one example, consider the case where a fire station near a particular area dispatches all of its ambulances. In this case, any additional ambulance calls in this area are likely to cause a fire station far from the area to dispatch its ambulance to the calling area. In this case, although there is a nearby fire station, a distant fire station is caused to dispatch its ambulance to the relevant area, taking time for the ambulance to arrive.

One possible way to address such a situation is to have an ambulance moved ahead of time to an area, for example, far from the fire station or near a fire station where there is no ambulance on standby for dispatch. Examples of methods of determining how to pre-move an ambulance include a determination by a person, calculation by a system, or the like.

However, areas that cannot be covered by such ambulance deployment are generally affected by the real-time operational status of a plurality of ambulances. It is not easy for humans to consider such real-time operational status of each ambulance to determine the deployment of ambulances. Furthermore, the adequacy determination of the ambulance deployment is challenging in any case, whether the ambulance deployment is determined by a human or a system, making it hard to obtain a feeling of reliability.

Further, collating the visualized demand prediction for ambulance calls with the current location of an ambulance for each area can evaluate ambulance deployment satisfaction. In addition to the location of the ambulance, further displaying the state of the ambulance, such as on standby or dispatching, or displaying only the ambulance in a predetermined state, is also possible. However, considering the whole area, it seems that there are many areas where the demand for ambulances is predicted, and the number of ambulances is large. It is highly challenging to make an appropriate decision considering all of such a wide variety of information. The prior art fails to process such a wide variety of information appropriately and then provide information that allows a unique recognition or determination of ambulance deployment satisfaction, such as index values using the time required for the ambulance to arrive, for example.

The disclosed technology, which is made in view of the above-mentioned points, is intended to visualize places where it takes time for an emergency vehicle to arrive.

### Solution to Problem

A first aspect of the present disclosure is a display control device including a display control unit configured to control a display unit to display location information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

A second aspect of the present disclosure is a display control method of causing a computer to execute processing including controlling a display unit to display location information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

A third aspect of the present disclosure is a display control program for causing a computer to execute processing including controlling a display unit to display location information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

A fourth aspect of the present disclosure is a display control device including: an estimation unit that estimates, on the basis of a predictive distribution of an occurrence point representing a point where a call for an emergency vehicle occurs, an occurrence time at which a call occurs at the occurrence point for each of a plurality of the occurrence points; a simulation unit that executes a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as a result of estimation by the estimation unit and an operational status of each of the plurality of emergency vehicles; a calculation unit that, on the basis of a result of simulation by the simulation unit, extracts, from the plurality of occurrence points, an occurrence point at which a distance between the emergency vehicle available for dispatch and the occurrence point is equal to or greater than a threshold value, and calculates a risk level such that the risk level of an area to which the extracted occurrence point belongs becomes high; and a display control unit that controls a display unit to display the risk level calculated by the calculation unit.

A fifth aspect of the present disclosure is a display control method in which a computer executes processing including: estimating, on the basis of a predictive distribution of an occurrence point representing a point where a call for an emergency vehicle occurs, an occurrence time at which a call occurs at the occurrence point for each of a plurality of the occurrence points; executing a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as an estimation result and an operational status of each of the plurality of emergency vehicles; on the basis of a simulation result, extracting, from the plurality of occurrence points, an occurrence point at which a distance between the emergency vehicle available for dispatch and the occurrence point is equal to or greater than a threshold value, and calculating a risk level such that the risk level of an area to which the extracted occurrence point belongs becomes high; and controlling a display unit to display the calculated risk level.

### Advantageous Effects of Invention

According to the technology disclosed, it is possible to visualize a place where it takes time for an emergency vehicle to arrive.

### BRIEF DESCRIPTION OF DRAWINGS

FIG. 1 is a diagram illustrated to describe a predictive distribution according to the present embodiment.

FIG. 2 is a diagram illustrated to describe a risk level distribution according to the present embodiment.

FIG. 3 is a diagram illustrated to describe a risk level distribution according to the present embodiment.

FIG. 4 is a block diagram illustrating a hardware configuration of a display control device.

FIG. 5 is a block diagram illustrating a functional configuration of a display control device according to first to third embodiments.

FIG. 6 is a diagram illustrated to describe location information of an ambulance.

FIG. 7 is a diagram illustrated to describe location information and an operational status of an ambulance.

FIG. 8 is a diagram illustrated to describe location information and an operational status of an ambulance.

FIG. 9 is a flowchart illustrating procedures of display control processing by the display control device according to the first embodiment.

FIG. 10 is a flowchart illustrating procedures of display control processing by the display control device according to the second embodiment.

FIG. 11 is a flowchart illustrating procedures of risk level calculation processing by the display control device according to the second embodiment.

FIG. 12 is a flowchart illustrating procedures of display control processing by the display control device according to the third embodiment.

FIG. 13 is a block diagram showing a functional configuration of a display control device according to a fourth embodiment.

FIG. 14 is a diagram illustrated to describe an occurrence point, an occurrence time, and a required time.

FIG. 15 is a diagram illustrated to describe an ambulance, an operational status, and a response completion time.

FIG. 16 is a flowchart illustrating procedures of display control processing by the display control device according to the fourth embodiment.

### DESCRIPTION OF EMBODIMENTS

Hereinafter, an example of an embodiment of the disclosed technology will be described with reference to the drawings. Note that the same or equivalent components and parts will be given the same reference numerals in the drawings. In addition, dimensional ratios in the drawings are exaggerated for convenience of description and thus may be different from actual ratios.

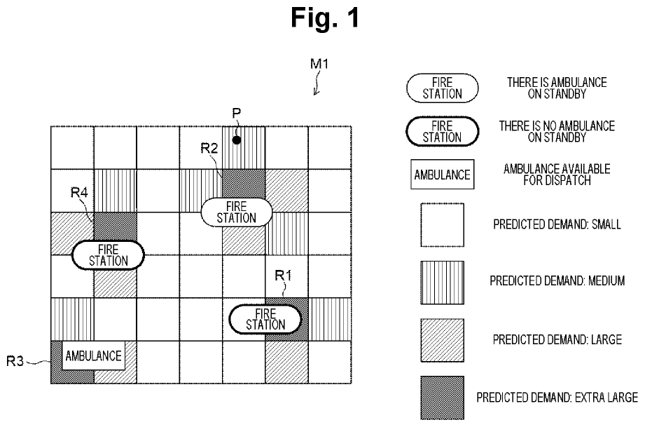

FIGS. 1 to 3 are diagrams for illustrating an overview of the present embodiment.

FIG. 1 is one example of a predictive distribution M1 for an occurrence point P representing a point where an ambulance call occurs. Such an ambulance is an example of an emergency vehicle. In the predictive distribution M1 of FIG. 1, the occurrence point P where the call is predicted to occur is plotted on map data partitioned into a plurality of meshes. In the predictive distribution M1, the demand for calling is predicted for each mesh.

As illustrated in FIG. 1, this predictive distribution visualizes the occurrence point where a call is predicted to occur. However, the predictive distribution illustrated in FIG. 1 does not visualize the amount of time required for an ambulance to arrive at a certain occurrence point when a call occurs at the occurrence point. In the example illustrated in FIG. 1, regions R1, R3, and R4 have the predictive demand of “extra large” and are located near a fire station with ambulances on standby or near an ambulance available for dispatch. Hence, it is expected that the time required for an ambulance to arrive at the regions R1, R3, and R4 is relatively short. On the other hand, a region R2 in FIG. 1 has the predictive demand of “extra large” and is located near a fire station, but this fire station has no ambulance on standby. Hence, it is expected that the time required for an ambulance to arrive at the region R2 is relatively long.

Therefore, the present embodiment visualizes places where it takes time for an emergency vehicle to arrive.

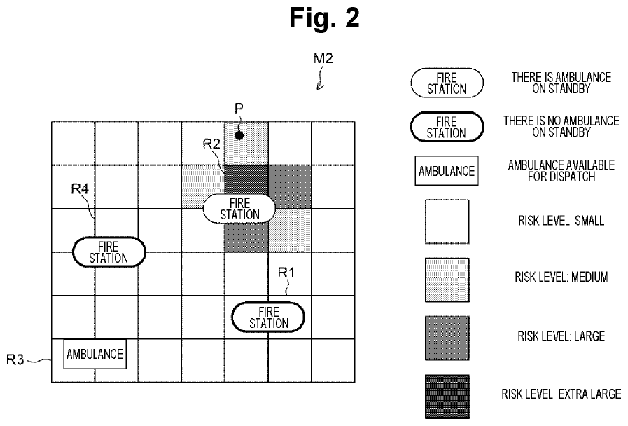

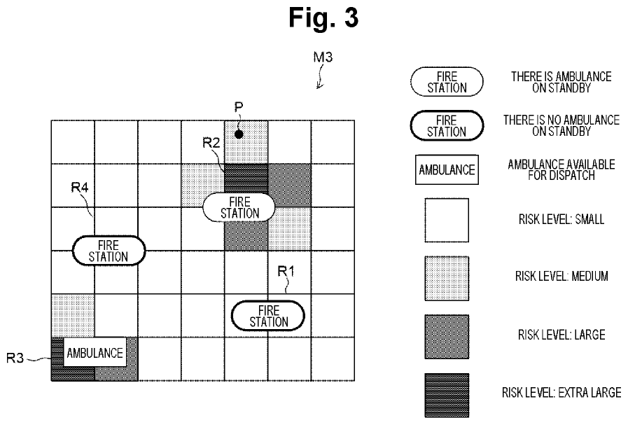

FIGS. 2 and 3 are diagrams illustrating an example of a risk level distribution M2 generated according to the present embodiment. As illustrated in FIG. 2, the risk level distribution M2 has a region R2 with the risk level of “extra large” and visualizes places where it takes time for an emergency vehicle to arrive.

Note that the risk level can be visualized for only an ambulance on standby at a fire station rather than all ambulances available for dispatch. This configuration allows the visualization to be made so that the risk level of an area far from an ambulance on standby at a fire station is higher. Using this risk level allows a route for an ambulance outside a fire station to be set. In addition, upon setting the route for an ambulance outside a fire station, it is possible to use such a risk level to determine the adequacy of the route.

In one example, as illustrated in FIG. 3, a risk level distribution M3 has a region R3 also having the risk level of “extra large” and visualizes the risk level of places where it takes time for an emergency vehicle to arrive. In the example of FIG. 3, the region R3 has a large risk level even though an ambulance is nearby. This is because the region R3 has a nearby ambulance being moving and is far from a fire station where an ambulance is on standby. On the other hand, the region R4 has the risk level of “small” because there is a fire station nearby where an ambulance is on standby.

As described above, the present embodiment calculates and visualizes the risk level of a region not covered by an ambulance. Note that the present embodiment considers the operational status of the ambulance and uses location information of an ambulance available for dispatch, allowing an occurrence point not covered to be extracted. Further, in the present embodiment, considering the ease of dispatching an ambulance available for dispatch, the occurrence points existing near an ambulance that is easy to dispatch are set so that their risk levels are higher. This configuration makes it possible to visualize a place where it takes time for an emergency vehicle such as an ambulance to arrive in a case where the emergency vehicle such as an ambulance is called. In addition, the present embodiment also makes it possible to support the work of deploying ambulances.

### First Embodiment

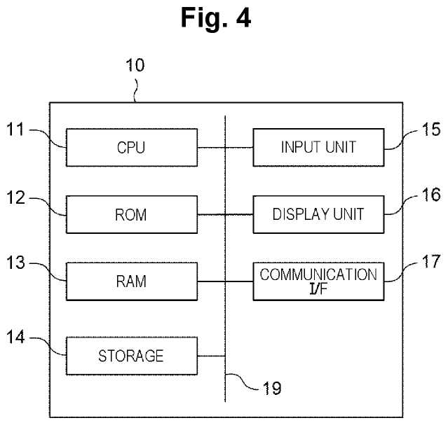

FIG. 4 is a block diagram illustrating a hardware configuration of a display control device 10.

As illustrated in FIG. 4, the display control device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, which executes various programs and controls each unit. That is, the CPU 11 reads a program from the ROM 12 or the storage 14, and executes the program using the RAM 13 as a work area. The CPU 11 performs control of each of the above-described components and various types of operation processing according to a program stored in the ROM 12 or the storage 14. In the present embodiment, the ROM 12 or the storage 14 stores a language processing program for converting a voice input by a mobile terminal 20 into characters.

The ROM 12 stores various programs and various types of data. The RAM 13 serving as a work area temporarily stores programs or data. The storage 14 is configured with a storage device such as a hard disk drive (HDD) or a solid state drive (SSD), and stores various programs including an operating system and various types of data.

The input unit 15 includes a pointing device such as a mouse and a keyboard, and is used to perform various inputs.

The display unit 16 is, for example, a liquid crystal display, and displays various types of information. The display unit 16 may function as the input unit 15 by adopting a touch panel system.

The communication interface 17 is an interface for communicating with another device such as a portable terminal. For the communication, for example, a wired communication standard such as Ethernet (registered trademark) or FDDI, or a wireless communication standard such as 4G, 5G, or Wi-Fi (registered trademark) is used.

Next, a functional configuration of the display control device 10 will be described.

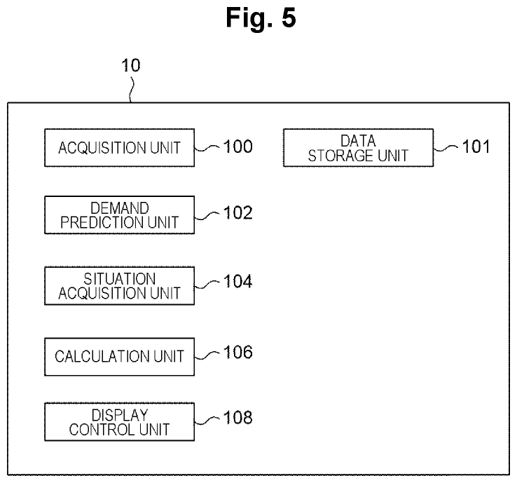

FIG. 5 is a block diagram illustrating an example of a functional configuration of the display control device 10.

As illustrated in FIG. 5, the display control device 10 includes, as functional configurations, an acquisition unit 100, a data storage unit 101, a demand prediction unit 102, a situation acquisition unit 104, a calculation unit 106, and a display control unit 108. Each functional configuration is implemented by the CPU 11 reading a display control program stored in the ROM 12 or the storage 14, loading the display control program to the RAM 13, and executing the display control program.

The acquisition unit 100 acquires various types of data from a command board system (not illustrated) in which various types of data of each one of a plurality of ambulances are collected. In addition, the acquisition unit 100 may acquire various types of data from an external server (not illustrated) different from the command board system. Then, the acquisition unit 100 stores the acquired various types of data in the data storage unit 101.

The data storage unit 101 stores various types of data acquired by the acquisition unit 100. For example, the data stored in the data storage unit 101 includes, for each one of the plurality of ambulances, a dispatch availability status of the ambulance, location information of the ambulance, location information of the fire station to which the ambulance is assigned, identification information of the fire station to which the ambulance is assigned, and information indicating a combination of a location from which the ambulance was called in the past and time, and the like. Thus, new data is stored every moment in the data storage unit 101.

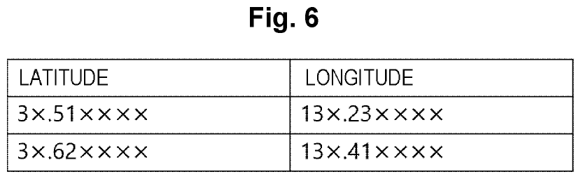

The demand prediction unit 102 generates a predictive distribution representing a demand prediction of occurrence points indicating locations from which an ambulance is called. In one example, the demand prediction unit 102 generates a predictive distribution of the occurrence point on the basis of information, which is stored in the data storage unit 101 and represents a combination of a location from which the ambulance was called in the past and time. In one example, on the basis of points where calls have been made in the past for each mesh representing a particular region on map data, the demand prediction unit 102 performs sampling on the points for each mesh. The demand prediction unit 102 then obtains latitude and longitude information of a plurality of occurrence points that are expected to be called for each mesh on the map data. Note that if the number of occurrence points can be predicted by month or day of the week, as a simpler method, the demand prediction unit 102 can extract the data corresponding to the same month or day of the week in the past and use the latitude and longitude information thereof as the location information of the occurrence point. In this case, for example, the latitude and longitude information, such as those illustrated in FIG. 6, can be obtained as the location information of the occurrence point.

Alternatively, for example, the demand prediction unit 102 may generate the predictive distribution of occurrence points by using a learned model that has been trained in advance by machine learning with the use of emergency transport information, information regarding past population of each place, information regarding past weather of each place, and the like.

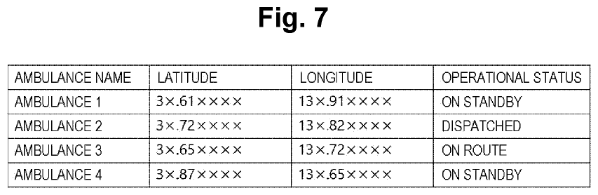

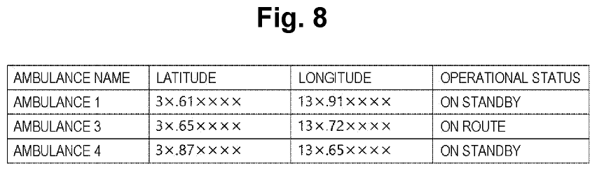

The situation acquisition unit 104 acquires information regarding an ambulance available for dispatch from the data storage unit 101. In one example, the situation acquisition unit 104 acquires information regarding an ambulance available for dispatch by acquiring data as illustrated in FIG. 8 from data stored in the data storage unit 101 and illustrated in FIG. 7.

Examples of an ambulance available for dispatch include an ambulance on standby at a fire station, an ambulance moving outside a fire station, such as ambulances on its way back or moving to another fire station, and an ambulance on standby somewhere outside a fire station. Note that in FIGS. 7 and 8, an ambulance with the operational status of “on route” represents a situation where the ambulance is not on standby at the fire station but is available for dispatch. Note that the situation acquisition unit 104 may not necessarily acquire “ambulance name”, that is, identification information used to identify an ambulance in this data processing procedure.

The calculation unit 106 calculates the risk level depending on the distance between one ambulance among a plurality of ambulances and the occurrence point on the basis of location information of the plurality of ambulances acquired by the situation acquisition unit 104 and the predictive distribution generated by the demand prediction unit 102.

Specifically, the calculation unit 106 identifies a target ambulance for each of a plurality of occurrence points in the predictive distribution generated by the demand prediction unit 102. The target ambulance indicates an ambulance having the shortest distance to the occurrence point among a plurality of ambulances.

In this configuration, N is a set of occurrence points and A is a set of ambulances available for dispatch. In this case, a distance dᵢⱼ when an ambulance j is called at an occurrence point i is calculated. Note that i is an element of N, and j is an element of A. In this case, a distance dᵢ from the occurrence point i to the nearest ambulance is expressed by Formula (1) below.

$$[ Math . 1 ]$$

$${d}_{i} = {min}_{j} {d}_{ij} \qquad ( 1 )$$

The calculation unit 106 then extracts the occurrence point, where the distance dᵢ between the target ambulance and the occurrence point i is equal to or greater than a threshold value dₜₕ, among the plurality of occurrence points. This allows a set of occurrence points {i|dₜₕ<dᵢ} existing at a location far from the nearest ambulance to be extracted.

The calculation unit 106 then plots the extracted occurrence points on the map data partitioned into the plurality of meshes. The calculation unit 106 calculates the risk level for each mesh included in the map data. The risk level is calculated so that the larger the number of occurrence points included in the mesh, the higher the risk level, and the smaller the number of occurrence points included in the mesh, the lower the risk level.

The display control unit 108 controls the display unit 16 to display the location information of the plurality of ambulances acquired by the situation acquisition unit 104, the predictive distribution generated by the demand prediction unit 102, and the risk level calculated by the calculation unit 106. The display control unit 108 visualizes the risk level of each mesh included in the map data. Note that it is also possible to not display the predictive distribution and only visualize the risk level.

Next, operations of the display control device 10 will be described.

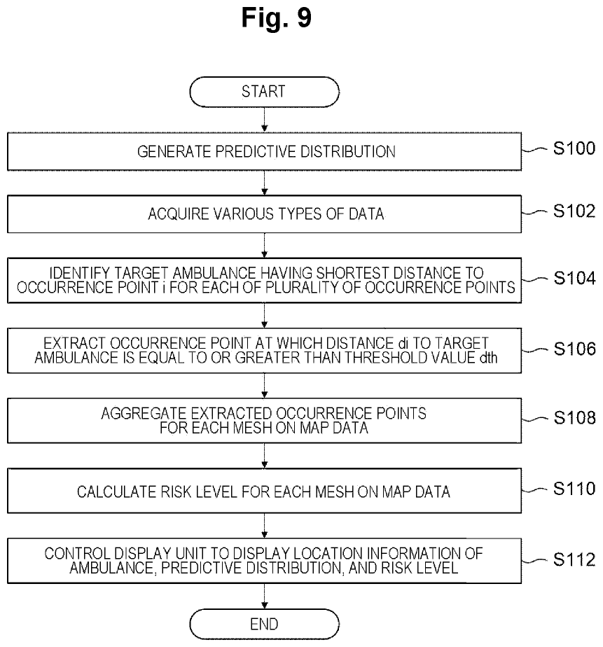

FIG. 9 is a flowchart illustrating procedures of display control processing by the display control device 10. The display control processing is performed by the CPU 11 reading a display control processing program from the ROM 12 or the storage 14, loading the display control processing program in the RAM 13, and executing the display control processing program.

In step S100, the CPU 11 functions as the demand prediction unit 102 to generates a predictive distribution representing a demand prediction of occurrence points indicating locations from which an ambulance is called.

In step S102, the CPU 11 functions as the situation acquisition unit 104 to acquire, for each one of the plurality of ambulances, a dispatch availability status of the ambulance, location information of the ambulance, location information of the fire station to which the ambulance is assigned, and identification information of the fire station to which the ambulance is assigned, and the like, from the data storage unit 101.

In step S104, the CPU 11 functions as the calculation unit 106 to identify a target ambulance among the plurality of ambulances for each of the plurality of occurrence points in the predictive distribution generated in step S100. The target ambulance indicates the ambulance having the shortest distance to the occurrence point.

In step S106, the CPU 11 functions as the calculation unit 106 to extract an occurrence point at which the distance between the target ambulance identified in step S104 and the occurrence point is equal to or greater than a threshold value among the plurality of occurrence points.

In step S108, the CPU 11 functions as the calculation unit 106 to plot the occurrence point extracted in step S106 on the map data partitioned into the plurality of meshes. The calculation unit 106 then aggregates the number of occurrence points for each mesh included in the map data.

In step S110, the CPU 11 functions as the calculation unit 106 to calculate the risk level for each mesh included in the map data so that the larger the number of occurrence points included in the mesh, the higher the risk level, and the smaller the number of occurrence points included in the mesh, the lower the risk level.

In step S112, the CPU 11 functions as the display control unit 108 to control the display unit 16 to display the location information of the plurality of ambulances acquired in step S102, the predictive distribution generated in step S100, and the risk level calculated in step S110.

As described above, the display control device according to the first embodiment causes the display unit to display location information of an ambulance, which is an example of an emergency vehicle, predictive distribution of an occurrence point indicating a point where an ambulance call occurs, and a risk level corresponding to distance information indicating the distance between the ambulance and the occurrence point. This configuration makes it possible to visualize a place where it takes time for an emergency vehicle to arrive in a case where the emergency vehicle is called.

### Second Embodiment

Next, a second embodiment will be described. The second embodiment differs from the first embodiment in that an ambulance is set in the center of a cluster, and the occurrence point is assigned to the cluster, calculating the risk level on the basis of the result. Note that a display control device according to the second embodiment has a configuration similar to that of the first embodiment, and the same reference numerals are given and description thereof is omitted.

An ambulance, if it is the closest target ambulance to a plurality of occurrence points, is easier to dispatch. In this case, even if the ambulance is nearby, the risk levels of the occurrence points need to be higher.

Thus, in the second embodiment, a cluster centered on an ambulance is configured for each ambulance, and a region included in the cluster is set as a region where the ambulance can meet the demand, calculating the risk level. Note that a cluster is, for example, a region indicating a predetermined range in the real space. Specifically, the second embodiment associates each occurrence point with a target ambulance, clustering the plurality of occurrence points. A target ambulance is an ambulance available for dispatch and the closest to the occurrence point. In this case, as many clusters as the number of ambulances available for dispatch are set. A set of occurrence points included in the cluster is a set of occurrence points existing within the range covered by the ambulance that is set in the center of the cluster.

Then, the second embodiment calculates the number of occurrence points belonging to a cluster corresponding to an ambulance. The second embodiment also extracts each of occurrence points belonging to a cluster in which the number of occurrence points assigned to the cluster corresponding to the ambulance is larger than a preset number. Then, the second embodiment calculates the risk level depending on the number of extracted occurrence points. Hereinafter, a specific description will be given.

In the second embodiment, the calculation unit 106 sets each of a plurality of ambulances to be each of the centers of a plurality of clusters.

The calculation unit 106 subsequently identifies a target ambulance representing an ambulance with the shortest distance to an occurrence point among a plurality of ambulances, which is similar to the first embodiment. The target ambulance is identified for each occurrence point in the predictive distribution generated by the demand prediction unit 102. The calculation unit 106 then assigns the occurrence points to the center of the cluster corresponding to the target ambulance.

In this regard, a target ambulance aᵢ for an occurrence point i is expressed by Formula (2) below.

$$[ Math . 2 ]$$

$${a}_{i} = arg {min}_{j} {d}_{ij} \qquad ( 2 )$$

Moreover, given that a cluster of an ambulance j is Cⱼ, then Cⱼ={i|aᵢ=j}.

The calculation unit 106 subsequently extracts each of the occurrence points where a distance dᵢ between the target ambulance aᵢ and the occurrence point i is equal to or greater than the threshold value dₜₕ, which is similar to the first embodiment. In addition, the calculation unit 106 extracts each of the occurrence points belonging to a cluster in which the number of assigned occurrence points is larger than a preset number.

Hereinafter, a specific description will be given.

Specifically, the calculation unit 106 first sets a positive constant bⱼ to the cluster Cⱼ of the ambulance j for each of the plurality of ambulances. The calculation unit 106 subsequently initializes a counter cⱼ corresponding to the cluster Cⱼ of the ambulance j by assigning zero. Note that a constant bⱼ can be designed to increase as the number of occurrence points to be processed by the ambulance j or the number of elements in N increases. A supplementary description for one of the meanings of the constant bⱼ is given below. The constant bⱼ can be regarded as the capacity for the demand of an ambulance. In other words, it is assumed that the capacity varies depending on the ambulance or regional characteristics. For this reason, the constant bⱼ can be designed depending on the ambulance or the place where the present embodiment is implemented.

The calculation unit 106 subsequently rearranges the distance dᵢ calculated for each of the plurality of occurrence points in ascending order. The calculation unit 106 then compares each of all the distances dᵢ belonging to the set N with the threshold value dₜₕ in order from the smallest distance dᵢ.

If the distance dᵢ is equal to or greater than the threshold value dₜₕ, the calculation unit 106 extracts the occurrence point i. On the other hand, if the distance dᵢ is less than the threshold value dₜₕ, the calculation unit 106 increments the counter cⱼ of the cluster Cⱼ to which the occurrence point i belongs by one.

The calculation unit 106 then compares the counter cⱼ of the cluster Cⱼ with a positive constant bⱼ, and if bⱼ<cⱼ, extracts each occurrence point belonging to the cluster Cⱼ. Note that it is also possible to extract an overflowing occurrence point instead of the occurrence point belonging to the cluster Cⱼ in which bⱼ<cⱼ holds. An overflowing occurrence point is, for example, an occurrence point that does not belong to any cluster in a case where the number of occurrence points belonging to the cluster Cⱼ exceeds the constant bⱼ. The occurrence point belonging to the cluster Cⱼ is determined on the basis of a predetermined reference, such as location or time.

This makes it easier to dispatch the ambulance j corresponding to the cluster Cⱼ in which the number of assigned occurrence points, indicated by cⱼ, is larger than the preset value bⱼ. Hence, the risk level of a region of a mesh including an occurrence point belonging to a cluster of such an ambulance is set to be higher.

Note that if the number of assigned occurrence points cⱼ is larger than the preset value bⱼ, the calculation unit 106 can extract the number of occurrence points corresponding to the difference between the constant bⱼ and the number of assigned occurrence points as the occurrence points that cannot be covered by the target ambulance.

Next, operations of the display control device 10 will be described.

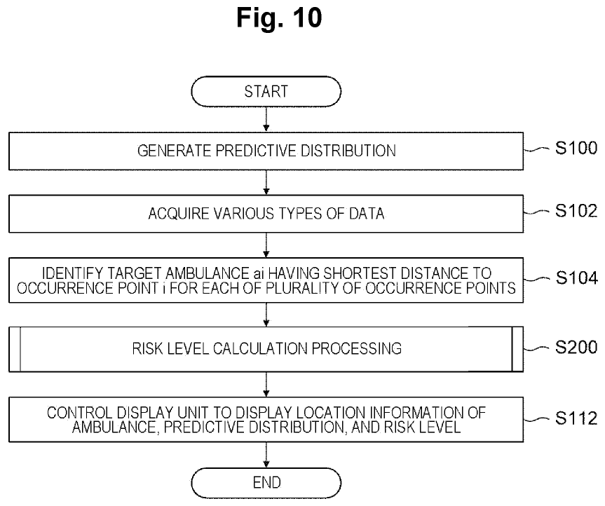

FIG. 10 is a flowchart illustrating procedures of display control processing by the display control device 10. The display control processing is performed by the CPU 11 reading a display control processing program from the ROM 12 or the storage 14, loading the display control processing program in the RAM 13, and executing the display control processing program.

Steps S100 to S104 and step S112 are executed similarly to those in the first embodiment.

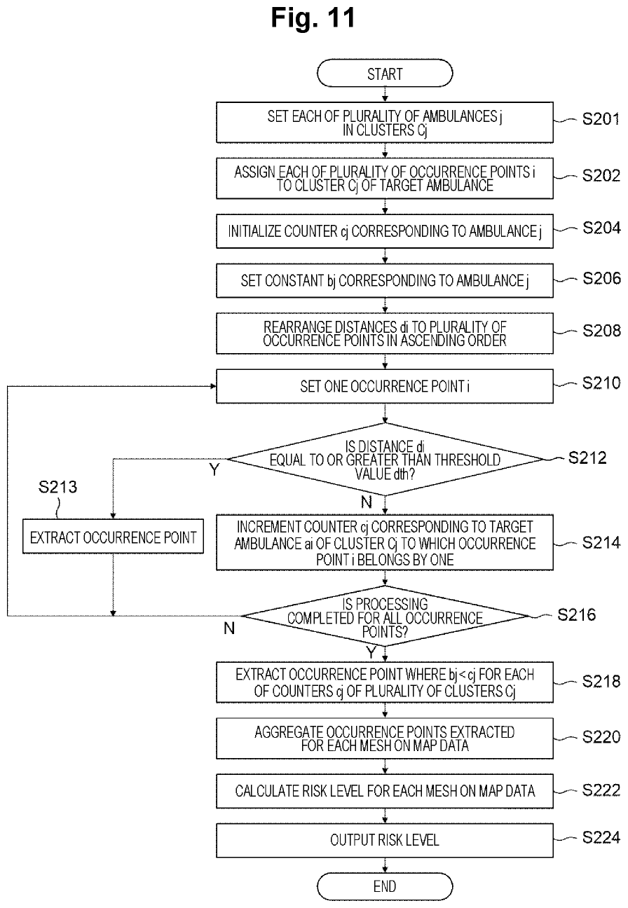

In step S200, the CPU 11 functions as the calculation unit 106 to calculate the risk level by executing the procedure of the flowchart illustrated in FIG. 11.

In step S201 of the flowchart illustrated in FIG. 11, the CPU 11 functions as the calculation unit 106 to set each of the plurality of ambulances j to be each of the centers of the plurality of clusters Cⱼ.

In step S202, the CPU 11 functions as the calculation unit 106 to assign each of the plurality of occurrence points i to the cluster Cⱼ of the target ambulance aᵢ.

In step S204, the CPU 11 functions as the calculation unit 106 to initialize the counter cⱼ corresponding to the ambulance j.

In step S206, the CPU 11 functions as the calculation unit 106 to set the constant bⱼ corresponding to the ambulance j.

In step S208, the CPU 11 functions as the calculation unit 106 to rearrange the distances dᵢ to the plurality of occurrence points in ascending order.

In step S210, the CPU 11 functions as the calculation unit 106 to set the occurrence point i.

In step S212, the CPU 11 functions as the calculation unit 106 to determine whether or not the distance dᵢ corresponding to the occurrence point i that is set in step S210 is equal to or greater than the threshold value dₜₕ. If the distance dᵢ is equal to or greater than the threshold value dₜₕ, the processing proceeds to step S213. On the other hand, if the distance dᵢ is less than the threshold value dₜₕ, the processing proceeds to step S214.

In step S213, the CPU 11 functions as the calculation unit 106 to extract the occurrence point i set in step S210, and then the processing returns to step S210.

In step S214, the CPU 11 functions as the calculation unit 106 to increment the counter cⱼ corresponding to the target ambulance aᵢ of the cluster Cⱼ to which the occurrence point i belongs by one.

In step S216, the CPU 11 functions as the calculation unit 106 to determine whether or not the processing of steps S201 to S214 is completed for all the occurrence points. If the processing of steps S210 to S214 is completed for all the occurrence points, the processing proceeds to step S218. If there is an occurrence point for which the processing of steps S210 to S214 is not completed, the processing returns to step S210.

In step S218, the CPU 11 functions as the calculation unit 106 to extract an occurrence point where bⱼ<cⱼ for each of the counters cⱼ of the plurality of clusters Cⱼ on the basis of the value of the counter in step S214 described above.

In step S220, the CPU 11 functions as the calculation unit 106 to aggregate the occurrence points extracted in step S213 and step S218 for each mesh on the map data.

In step S222, the CPU 11 functions as the calculation unit 106 to calculate the risk level for each mesh on the basis of the aggregation result obtained in step S220.

In step S224, the CPU 11 functions as the calculation unit 106 to output, as a result, the risk level calculated in step S222.

Note that other configurations and operations of the display control device according to the second embodiment are similar to those of the first embodiment, and thus, description thereof is omitted.

According to the second embodiment described above, the display control device sets each of a plurality of ambulances to be each of the centers of a plurality of clusters. The display control device also identifies a target ambulance representing the ambulance with the shortest distance to the occurrence point among a plurality of ambulances for each occurrence point in the predictive distribution. The display control device also assigns the occurrence point to the center of the cluster corresponding to the target ambulance. The display control device then extracts each of the occurrence points where the distance between the target ambulance and the occurrence point is equal to or greater than a threshold value and extracts each of the occurrence points belonging to the cluster in which the number of assigned occurrence points is larger than a preset number. The display control device plots the extracted occurrence points on map data partitioned into a plurality of meshes, calculating the risk level. In other words, according to the second embodiment, the display control device makes it possible to calculate the risk level obtained by associating the occurrence point with the number of ambulances that can cover the occurrence point. This risk level can incorporate the number of occurrence points that can be covered by the ambulance. This configuration makes it possible to visualize the risk level in consideration of the ease of dispatching an ambulance.

### Third Embodiment

Next, a third embodiment will be described. The third embodiment differs from the first and second embodiments in that the degree of dispatch, which indicates the ease of dispatching an ambulance, is further displayed. Note that a display control device according to the third embodiment has a configuration similar to that of the first embodiment, and the same reference numerals are given and description thereof is omitted.

A calculation unit 106 calculates, for each of a plurality of ambulances, the number of occurrence points having the ambulance identified as the target ambulance.

The calculation unit 106 then calculates the degree of dispatch for each of the plurality of ambulances so that the larger the number of occurrence points, the higher the degree of dispatch that indicates the ease of dispatching the ambulance depending on the number of occurrence points calculated for the ambulance. In addition, the calculation unit 106 calculates the degree of dispatch so that the smaller the number of occurrence points, the lower the degree of dispatch.

A display control unit 108 then controls a display unit 16 to further display the degree of dispatch calculated for each of the plurality of ambulances. Note that examples of the display form include a numerical value of the degree of dispatch or color-coded display.

Next, operations of the display control device 10 will be described.

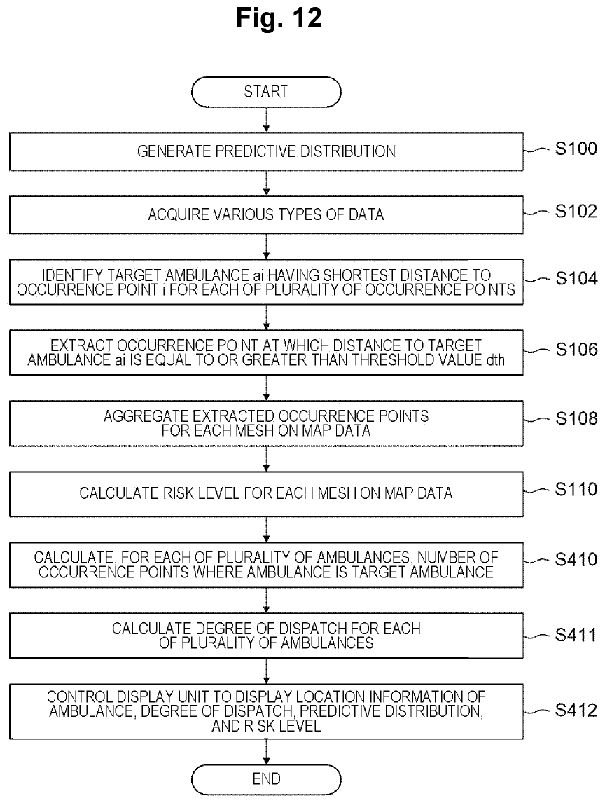

FIG. 12 is a flowchart illustrating procedures of display control processing by the display control device 10. The display control processing is performed by the CPU 11 reading a display control processing program from the ROM 12 or the storage 14, loading the display control processing program in the RAM 13, and executing the display control processing program.

Steps S100 to S110 are executed similarly to those in the first embodiment.

In step S410, the CPU 11 functions as the calculation unit 106 to calculate, for each of a plurality of ambulances, the number of occurrence points where the ambulance is identified as the target ambulance.

In step S411, the CPU 11 functions as the calculation unit 106 to calculate, on the basis of the calculation result obtained in the above step S410, the degree of dispatch for each of the plurality of ambulances so that the larger the number of occurrence points, the higher the degree of dispatch that indicates the ease of dispatching the ambulance depending on the number of occurrence points calculated for the ambulance. In addition, the calculation unit 106 calculates the degree of dispatch so that the smaller the number of occurrence points, the lower the degree of dispatch.

In step S412, the CPU 11 functions as the display control unit 108 to control the display unit 16 to further display the degree of dispatch calculated for each of the plurality of ambulances and obtained in step S411.

Note that other configurations and operations of the display control device according to the third embodiment are similar to those of the first or second embodiment, and thus, description thereof is omitted.

According to the third embodiment described above, the display control device calculates, for each of a plurality of ambulances, the number of occurrence points where the ambulance is identified as the target ambulance. The display control device then calculates the degree of dispatch for each of the plurality of ambulances so that the larger the number of occurrence points, the higher the degree of dispatch that indicates the ease of dispatching the ambulance depending on the number of occurrence points calculated for the ambulance. In addition, the display control device calculates the degree of dispatch so that the smaller the number of occurrence points, the lower the degree of dispatch. The display control device then controls the display unit to further display the degree of dispatch calculated for each of the plurality of emergency vehicles. This configuration makes it possible to further visualize the ease of dispatching an ambulance. In addition, there can be a case where the deployment of some ambulances is to vary, such as a case where the demand for calls fluctuates in some areas. In this case, the ambulances may be displayed, as movable ambulances, in order starting from an ambulance that is easy to dispatch, i.e., an ambulance with fewer occurrence points to cover. Alternatively, there can be a case where all ambulances in which the number of occurrence points covered by the ambulance is equal to or less than a predetermined threshold value are displayed as movable ambulances.

### Fourth Embodiment

Next, a fourth embodiment will be described. The fourth embodiment is different from the first to third embodiments in that an emergency activity of an ambulance is simulated and a risk level of an area to which an occurrence point belongs is calculated on the basis of the simulation result. Note that configurations of a display control device according to the fourth embodiment similar to those of the first to third embodiments are given the same reference numerals and description thereof is omitted.

In one example, consider the case where a fire station near a particular area dispatches all of its ambulances. Note that in the fourth embodiment, one mesh on the map data illustrated in FIGS. 1 to 3 is regarded as one area. Under such a situation, for example, there may be a case where an ambulance is newly called in the area, and an ambulance belonging to a fire station far from the area is dispatched to the area.

Therefore, the display control device according to the fourth embodiment simulates an emergency activity of an ambulance on the basis of a predictive distribution of an occurrence point representing a point where an ambulance call occurs, and calculates the risk level of each area corresponding to a mesh included in the map data on the basis of the simulation result. Specifically, the display control device according to the fourth embodiment calculates a distance between an occurrence point at which an ambulance call is predicted to occur and the ambulance on the basis of a simulation result. The display control device according to the fourth embodiment then extracts an occurrence point where the distance is equal to or greater than a threshold value dₜₕ, and increases the risk level of the area to which the occurrence point belongs.

A display control device 10 according to the first embodiment estimates the risk level of the area to which the occurrence point belongs on the basis of whether or not the distance to an ambulance closest to each occurrence point is equal to or greater than the threshold value dₜₕ. However, the display control device 10 according to the first embodiment does not consider the number of occurrence points that can be handled by one ambulance per unit time. Therefore, in the first embodiment, in a case where there are so many occurrence points that one ambulance cannot cope with, the risk level may not be appropriately visualized.

In addition, the display control device 10 according to the second embodiment identifies a cluster in which the number of occurrence points assigned to the cluster corresponding to the ambulance is larger than a preset number, and extracts each of the occurrence points belonging to the cluster. As a result, the risk level of the area exceeding the response capability of the ambulance is visualized. However, the method for visualizing the risk level by the display control device 10 according to the second embodiment is also based on a simplified calculation method.

For example, consider a case where the number of occurrence points in an area A exceeds the response capability of an ambulance a deployed in a fire station near the area A. Specifically, in a case where a first ambulance call occurs in the area A, and another ambulance call occurs in succession in the area A while the ambulance a is dispatched and performing an emergency activity, the response capacity of the ambulance a deployed in the fire station near the area A is exceeded. In this case, for example, assume that an ambulance b in an area B relatively close to the area A heads toward the area A. Then, in a case where there is a sick or injured person also in the area B at this timing and an ambulance call occurs in the area B as well, an ambulance c in an area C relatively close to the area B heads toward the area B. As described above, even in a case where the response capability of the ambulance b initially deployed in a fire station near the area B is not exceeded in the area B, there may be a case where an ambulance call occurs consequentially in the area B and the risk level of the area B increases.

Therefore, the display control device according to the fourth embodiment estimates the risk level of an area more precisely by simulating the situation as described above. Hereinafter, a specific description will be given.

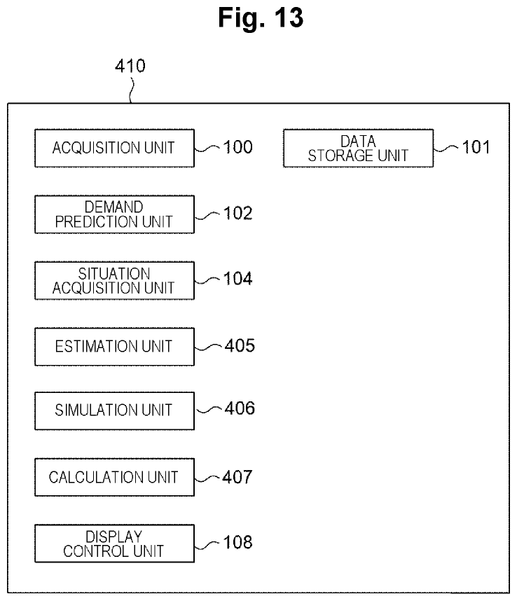

FIG. 13 is a block diagram illustrating an example of a functional configuration of a display control device 410 according to the fourth embodiment.

As illustrated in FIG. 13, the display control device 410 includes, as functional configurations, an acquisition unit 100, a data storage unit 101, a demand prediction unit 102, a situation acquisition unit 104, an estimation unit 405, a simulation unit 406, a calculation unit 407, and a display control unit 108. Each functional configuration is implemented by a CPU 21 reading an identification program stored in a ROM 22 or a storage 24, developing the identification program in a RAM 23, and executing the identification program.

The estimation unit 405 estimates an occurrence time at which a call occurs at each of a plurality of occurrence points on the basis of a predictive distribution generated by the demand prediction unit 102, and associates the occurrence point with the occurrence time.

For example, it may be predicted that an average of three ambulance calls occur per unit time in the area A, and an average of one an ambulance call occurs per unit time in the area B. It is known that, if it can be assumed that the number of times of ambulance calls follows the Poisson distribution in any area, the interval between the times of ambulance calls follows the exponential distribution. In this case, a method of simulating an occurrence time of an ambulance call in a pseudo manner is also known in the field of probability statistics.

Therefore, the estimation unit 405 estimates an occurrence time representing the time at which an ambulance call occurs for each of a plurality of occurrence points using a known technique. For example, the estimation unit 405 executes sampling based on a probability distribution generated by a known technique to estimate an occurrence time representing a time at which an ambulance call occurs at each of a plurality of occurrence points.

Next, the estimation unit 405 calculates, for each combination of the occurrence point and the occurrence time for each of the plurality of occurrence points, required time indicating the time required for an ambulance dispatched to the occurrence point at the occurrence time to respond. Then, the estimation unit 405 associates the combination of the occurrence point and the occurrence time with the calculated required time for each of the plurality of occurrence points. Note that this required time is the total time of the time required for an ambulance team to respond to the scene after the ambulance goes to the scene, the time required for transport from the scene to the hospital, and the like.

Note that, for example, if a certain tendency is known in advance for each area, the required time is set on the basis of the tendency. Alternatively, the estimation unit 405 may set a more simplified time such as an average in all areas as the required time.

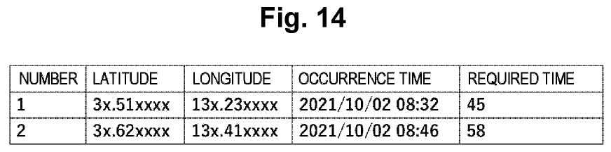

Then, the estimation unit 405 rearranges the combinations of the occurrence point, the occurrence time, and the required time for each of the plurality of occurrence points in order of occurrence time starting from the earliest time, and creates an occurrence time table as illustrated in FIG. 14. The estimation unit 405 stores the generated occurrence time table in the data storage unit 101. Note that the number of the occurrence time table is an identification number of the occurrence point.

The simulation unit 406 reads an operational status indicating the dispatch availability status of each of the plurality of ambulances from the data storage unit 101. Next, the simulation unit 406 reads the occurrence time of each of the plurality of occurrence points, which is the estimation result by the estimation unit 405, stored in the data storage unit 101. Then, the simulation unit 406 executes a simulation of an emergency activity in which any one of the plurality of ambulances available for dispatch is dispatched to the occurrence point at the occurrence time for each of the plurality of occurrence points on the basis of the occurrence time of each of the plurality of occurrence points and the operational status of each of the plurality of ambulances.

Specifically, the simulation unit 406 executes the simulation of an emergency activity in which, among the ambulances available for dispatch, the available ambulance requiring the shortest time to arrive at the occurrence point or the available ambulance having the shortest distance to the occurrence point is dispatched to the occurrence point at the occurrence time.

Next, the simulation unit 406 calculates, for each of the plurality of occurrence points, a round-trip time corresponding to a movement distance from the dispatched ambulance to the occurrence point.

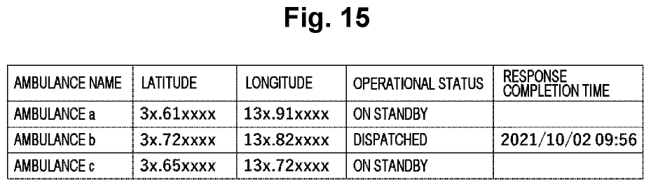

Then, the simulation unit 406 refers to the occurrence time table stored in the data storage unit 101 for each of the plurality of occurrence points, and adds the required time and the round-trip time to the occurrence time associated with the occurrence point, thereby calculating the response completion time representing the time when the dispatched ambulance completes the response. Then, the simulation unit 406 stores a simulation table as illustrated in FIG. 15 in the data storage unit 101. Note that the result of simulation executed by the simulation unit 406 is reflected in the operational status of the ambulance in the simulation table.

The calculation unit 407 extracts, from the plurality of occurrence points, an occurrence point at which the distance between an ambulance having the shortest distance to the occurrence point and available for dispatch and the occurrence point is equal to or greater than a threshold dₜₕ, and calculates the risk level such that the risk level of the area to which the extracted occurrence point belongs becomes high.

Specifically, the calculation unit 407 increments a counter of the risk level by one for an area belonging to an occurrence point at which the distance between an occurrence point and an ambulance available for dispatch is equal to or greater than the threshold value dₜₕ. Note that the calculation unit 407 performs setting so that an ambulance that has already been called and dispatched cannot be dispatched in a time zone earlier than a response completion time in the simulation table. In addition, it is assumed that an ambulance that has already been called and dispatched returns to the original location of the fire station after the response completion time. For each of the plurality of occurrence points existing in the occurrence time table, the calculation unit 407 calculates the risk level of the area to which the occurrence point belongs on the assumption that an ambulance call has occurred at the occurrence point.

As in the case of the first embodiment, the display control unit 108 controls a display unit 16 to display the location information of the plurality of ambulances acquired by the situation acquisition unit 104, the predictive distribution generated by the demand prediction unit 102, and the risk level calculated by the calculation unit 407.

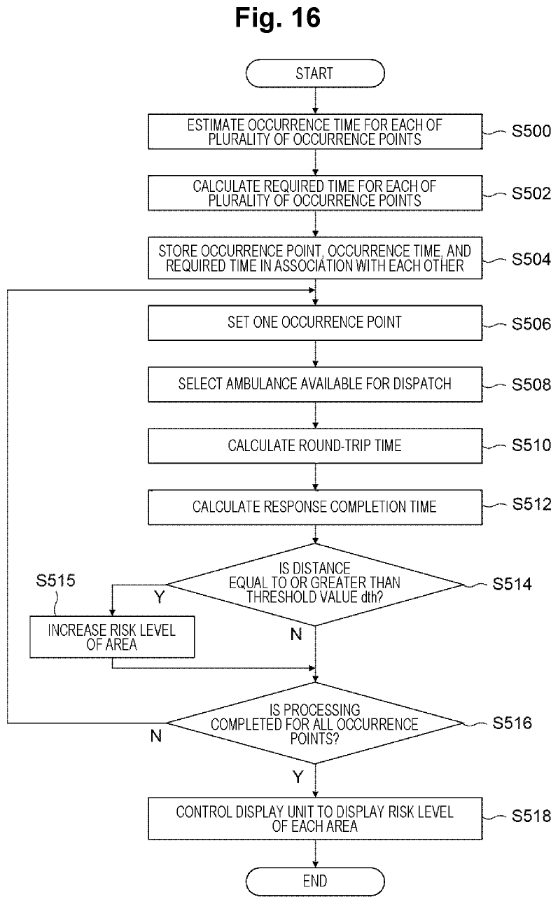

Next, operations of the display control device 410 according to the fourth embodiment will be described. FIG. 16 is a flowchart illustrating procedures of display control processing by the display control device 410. The display control processing is performed by the CPU 11 reading a display control processing program from the ROM 12 or the storage 14, loading the display control processing program in the RAM 13, and executing the display control processing program.

In step S500, the CPU 11 functions as the estimation unit 405 to estimates an occurrence time at which an ambulance call occurs for each of a plurality of occurrence points on the basis of a predictive distribution generated by the demand prediction unit 102.

In step S502, the CPU 11 functions as the estimation unit 405 to calculate, for each of the plurality of occurrence points, a required time required for the ambulance dispatched to the occurrence point at the occurrence time to respond.

In step S504, the CPU 11 functions as the estimation unit 405 to store, for each of the plurality of occurrence points, the occurrence point, the occurrence time estimated in step S500, and the required time calculated in step S502 in association with each other in the data storage unit 101 as an occurrence time table.

In step S506, the CPU 11 functions as the simulation unit 406 to read the operational status of each of the plurality of ambulances from the data storage unit 101. Next, in step S506, the CPU 11 functions as the simulation unit 406 to read the occurrence time table stored in the data storage unit 101. Then, in step S506, the CPU 11 functions as the simulation unit 406 to set one occurrence point from the plurality of occurrence points stored in the occurrence time table.

In step S508, the CPU 11 functions as the simulation unit 406 to refer to the operational status of each of the plurality of ambulances read in step S506, and selects one ambulance among the ambulances available for dispatch. Specifically, the CPU 11 functions as the simulation unit 406 to select an ambulance available for dispatch having the shortest time required to arrive at the occurrence point set in step S506 or an ambulance available for dispatch having the shortest distance to the occurrence point set in step S506.

In step S510, the CPU 11 functions as the simulation unit 406 to calculate the round-trip time according to the movement distance from the ambulance selected in step S508 to the occurrence point set in step S506.

In step S512, the CPU 11 functions as the simulation unit 406 to refer to the occurrence time table read in step S506, and adds the round-trip time calculated in step S510 and the required time of the occurrence time table to the occurrence time associated with the occurrence point set in step S506, thereby calculating a response completion time representing the time when the dispatched ambulance completes the response.

In step S514, the CPU 11 functions as the calculation unit 407 to determine whether or not a distance between an ambulance available for dispatch having the shortest distance to the occurrence point among the plurality of ambulances and the occurrence point set in step S506 is equal to or greater than a threshold value dₜₕ. In a case where the distance between the ambulance available for dispatch and the occurrence point is equal to or greater than the threshold value dₜₕ, the processing proceeds to step S515. On the other hand, when the distance between the ambulance available for dispatch and the occurrence point is less than the threshold value dₜₕ, the processing proceeds to step S516.

In step S515, the CPU 11 functions as the calculation unit 407 to increase the risk level of an area to which the occurrence point set in step S506 belongs such that the risk level of the area becomes high. Specifically, the CPU 11 functions as the calculation unit 407 to increment a counter of the risk level by one for the area belonging to the occurrence point.

In step S516, the CPU 11 functions as the calculation unit 407 to determine whether or not the processing of steps S506 to S515 has been executed for all the occurrence points existing in the occurrence time table. In a case where the processing of steps S506 to S515 is executed for all the occurrence points existing in the occurrence time table, the processing proceeds to step S518. On the other hand, if there is an occurrence point for which the processing of steps S506 to S515 is not completed, the processing returns to step S506.

In step S518, the CPU 11 functions as the display control unit 108 to control the display unit 16 to display the risk level of each area calculated in step S516.

Note that as described earlier, if it can be assumed that the number of occurrence points follows the Poisson distribution, the interval between the occurrence times follows the exponential distribution, and the occurrence time can be simulated in a pseudo manner. In this case, various patterns of the time-series data are conceivable even though a certain tendency is common. Therefore, statistical reliability may be enhanced by creating a plurality of pieces of time-series data, executing simulation with all of them, and calculating an average risk level of each area.

Note that other configurations and operations of the display control device according to the fourth embodiment are similar to those of the first, second, or third embodiment, and thus, description thereof is omitted.

As described above, the display control device of the fourth embodiment estimates an occurrence time at which a call occurs at an occurrence point for each of a plurality of occurrence points on the basis of a predictive distribution of an occurrence point representing a point where an ambulance call occurs. The display control device executes a simulation of an emergency activity in which any one of the plurality of ambulances available for dispatch is dispatched to the occurrence point at the occurrence time for each of the plurality of occurrence points on the basis of the occurrence time of each of the plurality of occurrence points that is the estimation result and the operational status of each of the plurality of ambulances. On the basis of the simulation result, the display control device extracts, from the plurality of occurrence points, an occurrence point at which the distance between an ambulance available for dispatch and the occurrence point is equal to or greater than a threshold, and calculates the risk level such that the risk level of an area to which the extracted occurrence point belongs becomes high. The display control device controls the display unit to display the calculated risk level. This makes it possible to visualize a place where it takes time for an ambulance to arrive. Specifically, since the risk level of an area represents the amount of time required for the arrival of an ambulance, it is possible to visualize a place where it takes time for the arrival of the ambulance by accurately calculating the risk level.

In addition, with the above processing, an occurrence point where the distance to an ambulance available for dispatch is equal to or greater than a threshold value is counted for each area, and the risk level of each area can be visualized more precisely than the first to third embodiments.

The display control processing, which is performed by the CPU reading software (program) in each of the above embodiments, may be performed by various processors other than the CPU. Examples of the processor in this case include a programmable logic device (PLD) in which a circuit configuration can be changed after manufacturing a field-programmable gate array (FPGA) or the like, and a dedicated electric circuit that is a processor having a circuit configuration exclusively designed for performing specific processing such as an application specific integrated circuit (ASIC). In addition, the display control processing may be performed by one of these various processors, or may be performed by a combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

In each of the above embodiments, the aspect in which the display control processing program is stored (installed) in advance in the storage 14 has been described, but this is not restrictive. The program may be provided in a form stored in a non-transitory storage medium such as a compact disk read only memory (CD-ROM), a digital versatile disk read only memory (DVD-ROM), and a universal serial bus (USB) memory. In addition, the program may be downloaded from an external device via a network.

Further, the above embodiment describes the case where an emergency vehicle is targeted as an example, but the present embodiment is not limited to this exemplary case. In one example, the present embodiment is applicable as long as it is a case where a moving body is called according to a predetermined demand. Hence, the above embodiment describes the case where the emergency vehicle is an ambulance as an example, but the present embodiment is not limited to this exemplary case. In one example, the emergency vehicle can be a police vehicle.

Further, the above embodiment describes the case where the risk level is calculated depending on a distance representing the distance between an emergency vehicle and an occurrence point as an example, but the present embodiment is not limited to this exemplary case. In one example, the risk level can be calculated depending on the time required from the call of the emergency vehicle to the arrival of the emergency vehicle at the occurrence point. In this case, for example, when the time required from the call of the emergency vehicle to the arrival of the emergency vehicle at the occurrence point is equal to or greater than a predetermined threshold value, the occurrence point is extracted and plotted on the map data.

Further, the above embodiment describes the case where the risk level is calculated using the latitude and longitude information of the occurrence point representing the point where the ambulance call occurs as an example, but the present embodiment is not limited to this exemplary case. In one example, the risk level can be calculated by treating one mesh on the map data as one occurrence point. In this case, for example, an expected value for calling an ambulance in one mesh can be calculated on the basis of past information, and the risk level can be calculated using the expected value.

Further, the second embodiment describes the example of extracting occurrence points belonging to a cluster in which the number of occurrence points belonging to the cluster is larger than a preset number, and calculating the risk level on the basis of the extracted occurrence points. However, the present embodiment is not limited to this example. In one example, it is possible to exclude an ambulance corresponding to a cluster in which the number of occurrence points belonging to the cluster is larger than a preset number and make the excluded ambulance unavailable for dispatch, performing the clustering again. In this case, the distance dᵢ and the target ambulance aᵢ are recalculated for each of the occurrence points i not belonging to any cluster Cⱼ. Then, the occurrence point i is assigned to the cluster Cⱼ of the ambulance j corresponding to the target ambulance aᵢ. Then, as in the second embodiment, if the distance dᵢ is equal to or greater than the threshold value dₜₕ, the occurrence point i is extracted, and if the distance dᵢ is less than the threshold value dₜₕ, the counter cⱼ of the cluster Cⱼ to which the occurrence point i belongs is incremented by one. The repetition of the processing allows the risk level to be calculated more appropriately. Moreover, such repetitive processing can end when a termination condition is satisfied, such as, for example, extraction of a predetermined number or more occurrence points, belonging of a certain number or less of occurrence points to one cluster, or, the number of occurrence points not belonging to any cluster being equal to or less than a predetermined number. In addition, when the occurrence point is the target, an example of the termination condition can include a decision to assign the occurrence point to a certain cluster, or a confirmation that the occurrence point cannot be assigned to any cluster (for example, a case where there is no ambulance that can cover the occurrence point, or a case where the distance from every ambulance exceeds the threshold value).

Further, the above embodiment describes the case where the risk level is calculated for each mesh as an example, but the present embodiment is not limited to this exemplary case. In one example, the risk level can be calculated for each point. Alternatively, the risk level can be displayed in a format such as contour lines.

While the embodiment of the present disclosure has been described above, the present disclosure is not limited to the above embodiment, and each component of a plurality of embodiments and various modifications may be appropriately combined.

With regard to the above embodiments, the following supplementary notes are further disclosed.

### (Supplementary Note 1)

A display control device
including
a memory and
at least one processor connected to the memory, in which
the processor is configured to
control a display unit to display location information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### (Supplementary Note 2)

A non-transitory storage medium storing a program executable by a computer to execute display control processing,
the display control processing including
controlling a display unit to display location information of an emergency vehicle, a predictive distribution of an occurrence point, and a risk level, the occurrence point representing a point at which a call for the emergency vehicle occurs, the risk level being determined depending on a time required for the emergency vehicle to arrive at the occurrence point after the call for the emergency vehicle occurs or a distance between the emergency vehicle and the occurrence point.

### (Supplementary Note 3)

A display control device including
a memory and
at least one processor connected to the memory, in which
the processor is configured to:
estimate, on the basis of a predictive distribution of an occurrence point representing a point where a call for an emergency vehicle occurs, an occurrence time at which a call occurs at the occurrence point for each of a plurality of the occurrence points;
execute a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as an estimation result and an operational status of each of the plurality of emergency vehicles;
on the basis of a simulation result, extract, from the plurality of occurrence points, an occurrence point at which a distance between the emergency vehicle available for dispatch and the occurrence point is equal to or greater than a threshold value, and calculate a risk level such that the risk level of an area to which the extracted occurrence point belongs becomes high; and
control a display unit to display the calculated risk level.

### (Supplementary Note 4)

A non-transitory storage medium storing a program executable by a computer to execute display control processing,
the display control processing including:
estimating, on the basis of a predictive distribution of an occurrence point representing a point where a call for an emergency vehicle occurs, an occurrence time at which a call occurs at the occurrence point for each of a plurality of the occurrence points;
executing a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as an estimation result and an operational status of each of the plurality of emergency vehicles;
on the basis of a simulation result, extracting, from the plurality of occurrence points, an occurrence point at which a distance between the emergency vehicle available for dispatch and the occurrence point is equal to or greater than a threshold value, and calculating a risk level such that the risk level of an area to which the extracted occurrence point belongs becomes high; and
controlling a display unit to display the calculated risk level.

### REFERENCE SIGNS LIST

100 Acquisition unit
101 Data storage unit
102 Demand prediction unit
104 Situation acquisition unit
106, 407 Calculation unit
108 Display control unit
405 Estimation unit
406 Simulation unit
10, 410 Display control device

1. A display control device comprising:
an estimation unit that estimates, on the basis of a predictive distribution of an occurrence point representing a point where a call for an emergency vehicle occurs, an occurrence time at which a call occurs at the occurrence point for each of a plurality of the occurrence points;
a simulation unit that executes a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as a result of estimation by the estimation unit and an operational status of each of the plurality of emergency vehicles;
a calculation unit that, on the basis of a result of simulation by the simulation unit, extracts, from the plurality of occurrence points, an occurrence point at which a distance between the emergency vehicle available for dispatch and the occurrence point is equal to or greater than a threshold value, and calculates a risk level such that the risk level of an area to which the extracted occurrence point belongs becomes high; and
a display control unit that controls a display unit to display the risk level calculated by the calculation unit.

2. The display control device according to claim 1, wherein:
the estimation unit calculates, for each of the plurality of occurrence points, a required time indicating a time required for an emergency vehicle dispatched to the occurrence point at the occurrence time to respond, for each combination of the occurrence point and the occurrence time;
the simulation unit calculates, for each of the plurality of occurrence points, a round-trip time according to a movement distance from the emergency vehicle available for dispatch to the occurrence point by executing the simulation of an emergency activity, and calculates a response completion time representing a time at which the emergency vehicle available for dispatch completes a response by adding the required time and the round-trip time to the occurrence time; and
the calculation unit sets, for each of a plurality of the emergency vehicles, that the emergency vehicle is not available for dispatch in a time zone earlier than the response completion time, extracts an occurrence point at which a distance between the emergency vehicle having a shortest distance to the occurrence point and available for dispatch and the occurrence point is equal to or greater than a threshold value, and calculates a risk level such that the risk level of an area to which the extracted occurrence point belongs becomes high.

3. The display control device according to claim 1, wherein
the simulation unit executes a simulation of an emergency activity in which an emergency vehicle available for dispatch requiring a shortest time to arrive at the occurrence point or an emergency vehicle available for dispatch having a shortest distance to the occurrence point is dispatched to the occurrence point at the occurrence time.

4. The display control device according to claim 1, wherein
the display control unit controls the display unit to display location information of a plurality of emergency vehicles, the predictive distribution, and the risk level calculated by the calculation unit.

5. A display control method in which a computer executes processing including:
estimating, on the basis of a predictive distribution of an occurrence point representing a point where a call for an emergency vehicle occurs, an occurrence time at which a call occurs at the occurrence point for each of a plurality of the occurrence points;
executing a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as an estimation result and an operational status of each of the plurality of emergency vehicles;
on the basis of a simulation result, extracting, from the plurality of occurrence points, an occurrence point at which a distance between the emergency vehicle available for dispatch and the occurrence point is equal to or greater than a threshold value, and calculating a risk level such that the risk level of an area to which the extracted occurrence point belongs becomes high; and
controlling a display unit to display the calculated risk level.

6. (canceled)

7. The display control method according to claim 5, wherein:
calculating, for each of the plurality of occurrence points, a required time indicating a time required for an emergency vehicle dispatched to the occurrence point at the occurrence time to respond, for each combination of the occurrence point and the occurrence time;
calculating, for each of the plurality of occurrence points, a round-trip time according to a movement distance from the emergency vehicle available for dispatch to the occurrence point by executing the simulation of an emergency activity, and calculates a response completion time representing a time at which the emergency vehicle available for dispatch completes a response by adding the required time and the round-trip time to the occurrence time; and
setting, for each of a plurality of the emergency vehicles, that the emergency vehicle is not available for dispatch in a time zone earlier than the response completion time, extracts an occurrence point at which a distance between the emergency vehicle having a shortest distance to the occurrence point and available for dispatch and the occurrence point is equal to or greater than a threshold value, and calculates a risk level such that the risk level of an area to which the extracted occurrence point belongs becomes high.

8. The display control method according to claim 5, wherein
executing a simulation of an emergency activity in which an emergency vehicle available for dispatch requiring a shortest time to arrive at the occurrence point or an emergency vehicle available for dispatch having a shortest distance to the occurrence point is dispatched to the occurrence point at the occurrence time.

9. The display control method according to claim 5, wherein
controlling the display unit to display location information of a plurality of emergency vehicles, the predictive distribution, and the risk level calculated.

10. A computer-readable non-transitory recording medium storing computer-executable program instructions that when executed by a processor cause a computer to execute a display control method comprising:
estimating, on the basis of a predictive distribution of an occurrence point representing a point where a call for an emergency vehicle occurs, an occurrence time at which a call occurs at the occurrence point for each of a plurality of the occurrence points;
executing a simulation of an emergency activity in which any one of a plurality of the emergency vehicles available for dispatch is dispatched to the occurrence point at the occurrence time for each of the plurality of occurrence points on the basis of the occurrence time of each of the plurality of occurrence points as an estimation result and an operational status of each of the plurality of emergency vehicles;
on the basis of a simulation result, extracting, from the plurality of occurrence points, an occurrence point at which a distance between the emergency vehicle available for dispatch and the occurrence point is equal to or greater than a threshold value, and calculating a risk level such that the risk level of an area to which the extracted occurrence point belongs becomes high; and
controlling a display unit to display the calculated risk level.

11. The display control method according to claim 10, wherein:
calculating, for each of the plurality of occurrence points, a required time indicating a time required for an emergency vehicle dispatched to the occurrence point at the occurrence time to respond, for each combination of the occurrence point and the occurrence time;
calculating, for each of the plurality of occurrence points, a round-trip time according to a movement distance from the emergency vehicle available for dispatch to the occurrence point by executing the simulation of an emergency activity, and calculates a response completion time representing a time at which the emergency vehicle available for dispatch completes a response by adding the required time and the round-trip time to the occurrence time; and
setting, for each of a plurality of the emergency vehicles, that the emergency vehicle is not available for dispatch in a time zone earlier than the response completion time, extracts an occurrence point at which a distance between the emergency vehicle having a shortest distance to the occurrence point and available for dispatch and the occurrence point is equal to or greater than a threshold value, and calculates a risk level such that the risk level of an area to which the extracted occurrence point belongs becomes high.

12. The display control method according to claim 10, wherein
executing a simulation of an emergency activity in which an emergency vehicle available for dispatch requiring a shortest time to arrive at the occurrence point or an emergency vehicle available for dispatch having a shortest distance to the occurrence point is dispatched to the occurrence point at the occurrence time.

13. The display control method according to claim 10, wherein
controlling the display unit to display location information of a plurality of emergency vehicles, the predictive distribution, and the risk level calculated by the calculation unit.

14. The display control device according to claim 1, wherein
a data storage unit includes, for each of a plurality of emergency vehicles, status of dispatch, location information of the plurality of emergency vehicles, location information of fire station to which the plurality of emergency vehicles belongs, identification information of the fire station, and combination of positions and times at which the plurality of emergency vehicles were called in the past.

15. The display control device according to claim 1, wherein
a demand forecasting unit generates a forecast distribution for occurrence points indicating locations where each of the plurality of emergency vehicles was called.

16. The display control device according to claim 15, wherein
the demand forecasting unit uses a learned model learned in advance by using a machine learning model using emergency transport information, past population information of each location, and past weather information of each location to generate a prediction distribution.

17. The display control device according to claim 1, wherein
the calculation unit plots extracted occurrence points in map data partitioned by a plurality of meshes and calculates degree of risk level for each of the plurality of meshes.

18. The display control device according to claim 16, wherein
the calculation unit calculates, for each of generation points in the prediction distribution, an object indicating the emergency vehicle having the shortest distance to the generation point and assigns the occurrence point to a center of a cluster corresponding to a target emergency vehicle.

19. The display control device according to claim 18, wherein
the calculation unit extracts each occurrence point where distance between the target emergency vehicle and the occurrence point is equal to or greater than a threshold and extracts one or more occurrence points belonging to the cluster in which a number of assigned occurrence points is greater than a threshold.

20. The display control method according to claim 7, wherein
generating a forecast distribution for occurrence points indicating locations where each of the plurality of emergency vehicles was called.

21. The display control method according to claim 20, wherein
using a learned model learned in advance by using a machine learning model using emergency transport information, past population information of each location, and past weather information of each location to generate a prediction distribution.
